(19) United States
(12) Patent Application Publication
(10) Pub. No.: US 2021/0209635 A1
(43) Pub. Date: Jul. 8, 2021

(54) Real Time Discount Marketplace

(71) Applicant: WITL, LLC, Brighton, MI (US)

(72) Inventors: Ronald J. Czajka, Brighton, MI (US); Sam B. Attisha, Las Vegas, NV (US)

(21) Appl. No.: 16/806,016

(22) Filed: Mar. 2, 2020

Related U.S. Application Data
(60) Provisional application No. 62/958,453, filed on Jan. 8, 2020.

(51) Int. Cl. G06Q 30/02; G06F 9/54

(52) U.S. Cl. CPC G06Q 30/0235; G06F 9/542; G06Q 30/0205; G06Q 30/0239

(57) ABSTRACT

A method includes receiving, from a user device of a user, a first request for a discount; identifying, based on the first request, matching discounts from respective vendors, wherein at least some of the matching discounts comprising respective expiration timestamps; forwarding the matching discounts to the user device; and receiving, from the user device, a second request to associate a selected matching discount of the matching discounts from a selected vendor with the user.

### CROSS-REFERENCE TO RELATED APPLICATION(S)

This application claims priority to and the benefit of U.S. Provisional Application Patent Ser. No. 62/958,453, filed Jan. 8, 2020, the entire disclosure of which is hereby incorporated by reference.

### TECHNICAL FIELD

This disclosure relates generally to electronic discounts and more specifically to user-requests for the electronic discounts.

### BACKGROUND

To entice consumers, vendors may issue coupons (e.g., discounts). A coupon entitles its holder to a discount that is typically on the face of the coupon and for a particular good or service of the issuing vendor. A consumer can obtain a coupon from a website, a newspaper insert, a vendor's mobile application, and the like. Such coupons tend to be generic to all consumers, not specific or customized to a particular consumer, and not pulled (e.g., requested, issued, etc.) on demand by a consumer. Additionally, vendors have no way of personalizing discounts to specific consumers and/or set rules related to the discounts.

### SUMMARY

A first aspect of the disclosed implementations is a method for use in a real-time discount marketplace. The method includes receiving, from a user device of a user, a first request for a discount; identifying, based on the first request, matching discounts from respective vendors, wherein at least some of the matching discounts comprising respective expiration timestamps; forwarding the matching discounts to the user device; and receiving, from the user device, a second request to associate a selected matching discount of the matching discounts from a selected vendor with the user.

A second aspect is a method for use in a real-time discount marketplace. The method includes receiving, from a user device of a user, a first request for a discount; identifying, based on the first request, matching discounts from respective vendors, wherein at least some of the matching discounts comprising respective expiration timestamps; receiving, from the user, a second request to redeem a selected matching discount from the matching discounts; and rejecting the redemption request in response to determining that the selected matching discount is not redeemable.

A third aspect is a system for use in a real-time discount marketplace. The system include a memory and a processor. The processor is configured to execute instructions stored in the memory to receive, from a user device of a user, a first request for a discount; identify, based on the first request, matching discounts from respective vendors, wherein at least some of the matching discounts comprising respective expiration timestamps; forward the matching discounts to the user device; receive, from the user device, a second request to associate a selected matching discount of the matching discounts from a selected vendor with the user; receive, from the user, a third request to redeem the selected matching discount from the matching discounts; and determine whether to redeem the discount based on the third request satisfying a campaign associated with the selected matching discount.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of an apparatus 100 used with a real-time discount marketplace in accordance with implementations of the present disclosure.

FIG. 2 is a diagram of an example of a system used with a real-time discount marketplace in accordance with implementations of the present disclosure.

FIG. 3 is a diagram of an example of modules of a system used with a real-time discount marketplace in accordance with implementations of the present disclosure.

FIG. 4 is a flowchart diagram of an example of a technique 400 that can be used in a real-time discount marketplace in accordance with an implementation of the present disclosure.

FIG. 5 illustrates an example of a user interface that can be used by a user to enter a request for discounts in accordance to implementations of this disclosure.

FIG. 6 illustrates a list of active first requests in accordance with implementations of this disclosure.

FIGS. 7A-7E illustrate user interfaces that can be used by a vendor including to create and/or modify campaigns in accordance with implementations of this disclosure.

FIGS. 8A-8B illustrate matching discounts in accordance with implementations of this disclosure.

FIG. 9 illustrates a user interface of a wallet in accordance with implementations of this disclosure.

FIG. 10 illustrates a redemption user interface for redeeming a discount in accordance with implementations of this disclosure.

FIG. 11 illustrates a map display in accordance with implementations of this disclosure.

FIG. 12 is a flowchart diagram of an example of a technique that can be used in a real-time discount marketplace in accordance with an implementation of the present disclosure.

### DETAILED DESCRIPTION

A non-limiting, high level overview of the disclosed implementations is now provided to aid in the understanding of the remainder of the disclosure.

A user can submit a query, which can include a description of a good or service (collectively referred to herein as “offering”) that the user is interested in. Based on the query, matching discounts from respective vendors are then identified. Matching discounts are identified based on active campaigns of the respective vendors. An active campaign can include rules, which are further described below, regarding the goods or services offered through the campaign, discount criteria, campaign monetary limits, when discounts issued according to the campaign can be redeemed, where discounts issued according to the campaign can be redeemed, what users can receive a discount according to the campaign, more, fewer, other rules, or a combination thereof.

The user can save one or more of the matching discounts for later use (e.g., redemption) in an electronic wallet. Once the query is received from the user, matching discounts can be received from the respective vendors for a predetermined period of time (e.g., 30 seconds, 1 minute, 2 minutes, or some other period of time). The predetermined period of time is referred to herein as a bidding time and it is the time during which vendors can generate matching discounts. That is, the bidding time is the time during which vendors can compete in the form of incremental discounts. After the bidding time expires, the matched discounts are locked (e.g., can no longer be modified) and presented to the user. In an example, the user can set the predetermined period of time (such as at the time of submitting the query or as a preset predetermined period of time that is associated with a profile of the user). A matching discount can be received from a vendor either automatically or manually.

An automatic matching discount can be identified based on a campaign (e.g., a marketing campaign, an advertisement campaign, etc.) that the vendor has set up. As mentioned, a campaign can include a set of rules for issuing discount offers to a requesting user (i.e., based on a user request). As such, an electronic agent (i.e., a vendor automated agent) can respond to user requests according to the rules of the campaigns set up by the vendor.

A manual matching discount can be manually generated by the vendor in response to the vendor receiving the query. For example, if the vendor has not set up a campaign that can be matched to the query, the vendor can elect to receive notifications of queries that at least match the vendor's products. The notification can be an email notification, a text message, a notification delivered via a custom application, some other notification, or a combination thereof.

In some examples, a vendor human agent (e.g., a manager at a store, a sales and marketing person, etc.) can be notified that the vendor's discount was not the highest discount amongst the matching discounts. In response to the notification, the vendor agent can issue a replacement matching discount, which may override some of the rules of the campaign matching the user request.

In some examples, a user can get rewards (such as in the form of bonus points) each time the user redeems a discount. A vendor can provide an incentive through additional bonus points to entice the user to use the vendor's discount. The user can accumulate bonus points, which can be applied as additional discount from vendors. In another example, the user can exchange the bonus points for a cash payout.

Various aspects of this disclosure are now described with reference to the drawings. In the following description, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

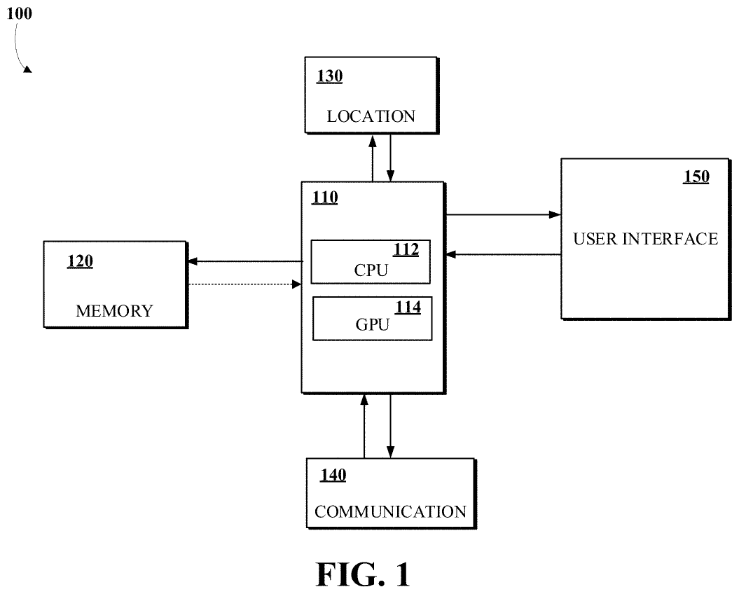

FIG. 1 is a diagram of an example of an apparatus 100 used with a real-time discount marketplace in accordance with implementations of the present disclosure.

The apparatus 100 can be a user device (e.g., a handheld device, a desktop device, a laptop device, etc.) that can be used by a user to issue requests for discounts, receive matching discounts, save a matching discount to a wallet, redeem a matching discount, other operations, or a combination thereof.

The apparatus 100 can be a centralized server (such as a cloud-based, network-based server, etc.) that can be used to receive requests from a user, identify matching discounts, forward the matching requests to a user device, receive a request to associate a matching discount with a user profile (e.g., a wallet of the user), receive a request to redeem a matching discount, other operations, or a combination thereof. The apparatus 100 can be a centralized server that can be used by a vendor to set up campaigns for issuing matching discounts according to rules of the set up campaigns.

The apparatus 100 can include a processor 110, a memory unit 120, a location component 130, a communication component 140, a user interface unit 150, or a combination thereof. The apparatus 100 may be an electronic device, which may be, without limitation, a smartphone, personal digital assistant, tablet computer, laptop computer, desktop computer or other Internet-connectable device.

The processor 110 can be one or more various computer processors used to process data and perform computing tasks including without limitation a central processing unit (CPU) 112, and/or a graphical processing unit (GPU) 114 as shown in FIG. 1. In some embodiments, the CPU 112 or GPU 114 may be implemented as a microcontroller, microprocessor, or an application specific integrated circuit (ASIC), or a combination thereof.

The memory unit 120 can be one or more various volatile and nonvolatile memory types including without limitation random access memory, read only memory, flash memory or other removable/non-removable storage media. The memory unit 120 can include a system memory module that can store executable computer instructions that, when executed by the processor 110, perform various user device functionalities or server device functionalities including those described herein. The memory unit 120 can store data, including, but limited to vendor information (e.g., vendor profile information, campaign rules, etc.) entered at least partially by a vendor and/or user information (e.g., user wallet information, bonus point information, redemption history, etc.) entered at least partially by the user via the user interface unit 150, received from the communication component 140, or generated using the techniques described herein.

The location component 130 can include, for example, a global positioning system module or geolocation module, which, based on its configuration, may be in communication with satellite or other external systems used for tracking the location of an electronic device (e.g., a user device). In some embodiments, the positioning data received by the location component 130 can be one or more of a set of coordinates and a common address (e.g., a street address along with corresponding city, state/province/country information). The location component 130 can identify a location of the apparatus 100 using positioning data.

The communication component 140 can send and receive electronic data. For example, in the case of a user device, the electronic data can include matching discounts, user queries, and redemption requests. For example, in the case of a server, the electronic data can include campaign rules, matching discounts, and redemption requests.

The communication component 140 can include, for example, a modem or other hardware module or adapter for connecting the electronic device to a network, such as an intranet, local network, or the Internet, either through a physical connection (e.g., Ethernet) or wireless connection (e.g., Wi-Fi). In some embodiments, the communication component can connect the user device to, and thereafter communicate with, a server and/or one or more other user devices.

The user interface unit 150 can include one or more units that may register or receive input or present outputs, such as a display, touch interface, a proximity sensitive interface, a light receiving/emitting unit, sound receiving/emitting unit, a wired/wireless unit, or other units. In some embodiments, the user interface unit 150 can include a display, one or more tactile elements (e.g., buttons or virtual touch screen buttons), lights (e.g., LED), speakers, or other user interface elements. The user interface unit 150 can receive user input and provide information to a user related to operation of the apparatus 100.

In some embodiments, the user interface unit 150 can include a display screen, such as a touch screen, for displaying information and receiving commands (such as from a user or from a vendor) to be processed. The user interface unit 150 can be supported by one or more input configurations including without limitation a keyboard and/or a mouse configuration, a touchscreen configuration, and a microphone and speaker configuration.

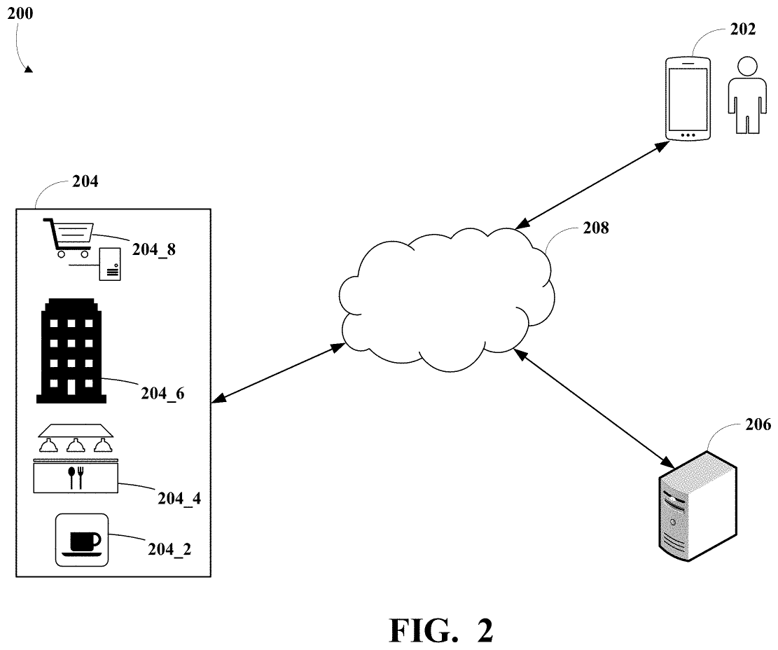

FIG. 2 is a diagram of an example of a system 200 used with a real-time discount marketplace in accordance with implementations of the present disclosure. In some embodiments, the system 200 can include a user device 202, which can be configured as shown and described herein with reference to apparatus 100 in FIG. 1. Although only one user device 202 is shown, it is to be understood that many user devices can be part of the system 200. The system 200 can also include a vendor 204, a network server 206, and a communication infrastructure 208. The vendor 204 can be any type of vendor that offers, for sale, goods and/or services. The vendor 204 can be, for example, a coffee shop 204_2, a restaurant 204_4, a department store 204_6, an e-commerce site 204_8, or any type of vendor. The vendor 204 communicates with the network server 206 via a vendor device, which can be configured as shown and described herein with reference to apparatus 100 in FIG. 1. The network server 206 can be configured as shown and described herein with reference to apparatus 100 in FIG. 1.

The communication infrastructure 208 can be or can include any type of networking mechanism via which the user device 202, the vendor 204 (i.e., a vendor device), and the network server 206 can exchange (e.g., send and/or receive) information, receive request, send requests, and the like. The communication infrastructure 208 can be or can include any one or combination of multiple different types of networks, such as cable networks, local area networks, personal area networks, wide area networks, the Internet, wireless networks, ad hoc networks, mesh networks, a satellite, a radio antenna, and/or the like.

In an example, the user device 202 can communicate with the network server 206 to set up the account profile of the user, submit queries for discount offers, save discount offers to a wallet, redeem or caused to be redeemed discount offers, perform other actions, or a combination thereof. In an example, the vendor 204 can communicate with the network server 206 to set up a vendor profile, set up one or more campaigns and the rules of the campaigns, receive notifications regarding requests for discounts from users, perform other actions, or a combination thereof.

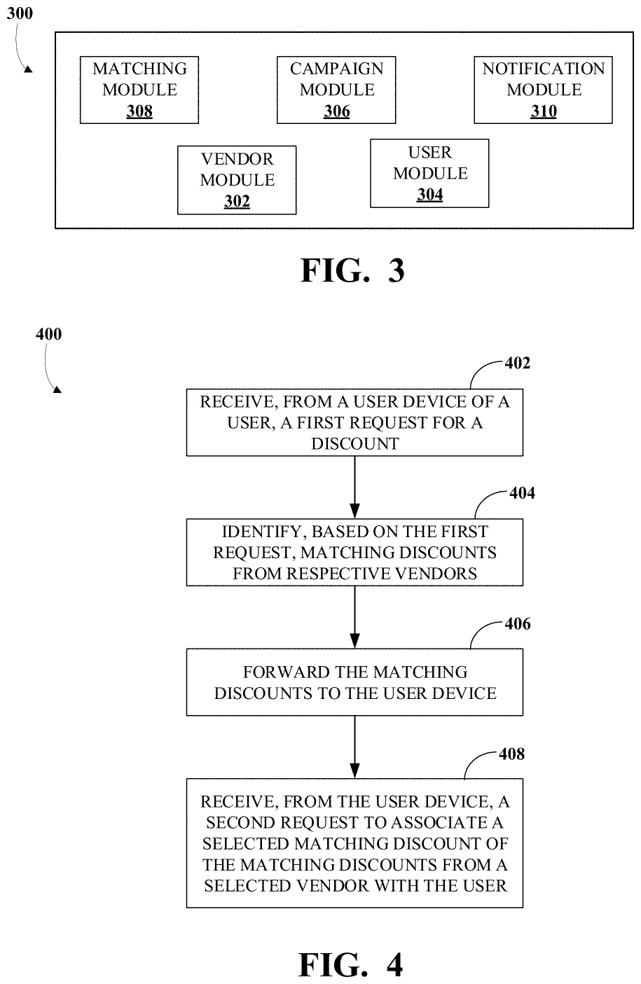

FIG. 3 is a diagram of an example of modules of a system 300 used with a real-time discount marketplace in accordance with implementations of the present disclosure. The system 300 can be or can be part of the network server 206 of FIG. 2. The system 300 can include a vendor module 302, a user module 304, a matching module 308, a campaign module 306, and a notification module 310. In some examples, two of more of the modules can be combined. In some examples, one or more of the modules can be split into more modules.

In some examples, the system 300 can include more, fewer, or other modules. For example, the system 300 can include an analytics module that can perform analysis related to campaigns, user redemption of matching discounts, user saves of matching discounts, and the like. A vendor can use the analytics information to create additional campaigns, extend campaigns, target certain user groups and/or locations, etc. For example, the system 300 can include a rewards module that can reward users with points when the users redeem matching discounts. The reward points awarded to a user can be used by the user to purchase other goods or services and/or can be redeemed by the user for cash.

The vendor module 302 can be used by a vendor, such as the vendor 204 of FIG. 2 to create and maintain a profile for the vendor. The user module 304 can be used by a user, via the user device 202 of FIG. 2, to create a user profile, which can include information regarding the user. For example, the user profile can include contact information (e.g., phone number, email address, physical address, preferences, etc.). The user profile can include or can be associated with a user wallet that includes discounts that the user saves for later use.

The matching module 308 can receive requests from a user for discounts, receive matching discounts for a predetermined period of time, and forward the matching discounts to the user. The matching module 308 can receive matching discounts from the campaign module 306 and/or directly from vendors.

A vendor can create discount campaigns using the vendor module 302. Alternatively, the vendor can create campaigns using the campaign module 306. Regardless of how campaigns are created, the campaign module can create (e.g., identify, generate, etc.) matching discounts according to the rules of active campaigns.

The notification module 310 can send notifications directly to a vendor. For example, a user request for a discount may be specifically for a discount from the vendor. The vendor may not have an active campaign, which can issue a matching discount in response to a user request. Thus, the notification module can be used to send a notification of the request directly to the vendor (e.g., to a vendor human agent). For example, in response to a request from a user, a first matching discount may be issued on behalf of a first vendor and a second matching discount may be issued on behalf of a second vendor. If the second matching discount is of higher value than the first discount. The first vendor can be notified so that the first vendor can optionally issue a matching discount of equal or higher value than the second discount.

FIG. 4 is a flowchart diagram of an example of a technique 400 that can be used in a real-time discount marketplace in accordance with an implementation of the present disclosure. The technique 400 can be implemented by a server, such as the network server 206 of FIG. 2. The technique 400 can be implemented by one or more of the modules of the system 300 of FIG. 3. The technique 400 can be stored in a memory, such as the memory unit 120 of FIG. 1, as executable instructions, which can be executed by a processor, such as the processor 110 of FIG. 1.

At 402, the technique 400 can receive, from a user device of a user, a first request for a discount. For example, the user can use the user device, such as the user device 202 of FIG. 2 to enter a request (e.g., a search) for discounts. The request can be received by the technique 400.

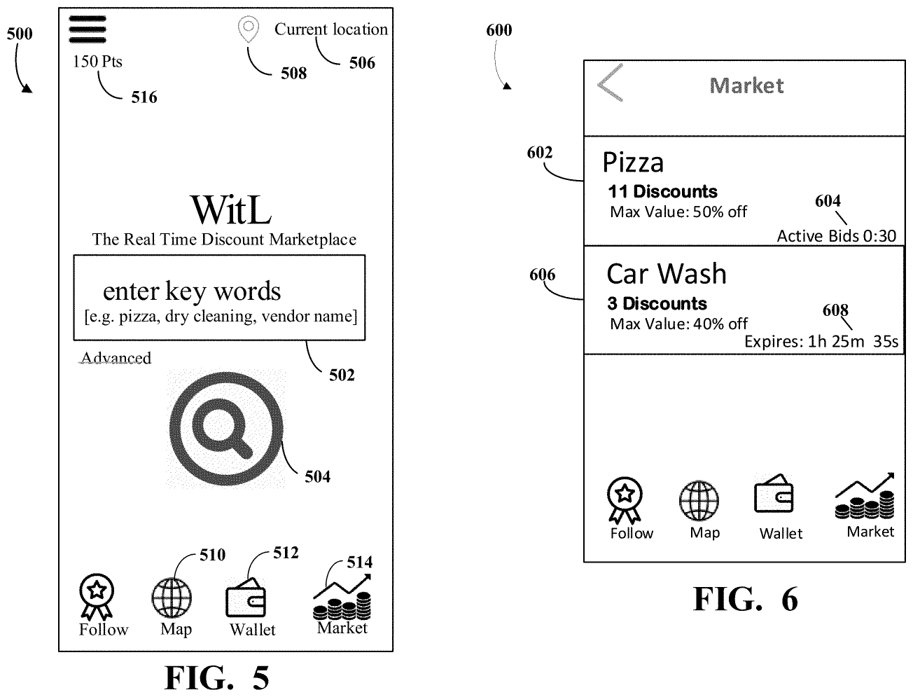

FIG. 5 illustrates an example of a user interface 500 that can be used by a user to enter a request for discounts in accordance to implementations of this disclosure. In an example, the user interface 500 can be or can be part of a website. In an example, the user interface 500 can be or can be a part of an application that may be installed on the user device 202.

In an example, the user can access the user interface 500 by first providing authentication credentials to gain access to an application or website (collectively, application) that provides the user interface 500. The authentication credentials can be sent to the server to verify the identity of the user and allow the user access to the user profile (and/or electronic wallet) of the user and/or submit search requests. In an example, the user can provide a username (or a phone number) and a password in a log in screen (not shown). In an example, the user can use a fingerprint, or some other biometric marker, as the authentication credentials. Other ways of authentication are possible. For example, the user can log in via the open standard authorization standard.

In an example, prior to accessing the user interface 500 for the first time, or part of saving a first discount to a wallet, the user may be required to register with the server to create a user profile. The registration process can require the user to provide a username, a phone number, and a password. The registration process can require the user to confirm the provided information. In an example, the confirmation (e.g., verification) process can send a verification code to the user (e.g., to an email or the phone number of the user), which the user then enters in a verification screen.

The user interface 500 includes an input field 502, which the user can use to issue a search for discounts. For example, the user may be about to take a lunch break and may be in the mood for pizza. Thus, the user can type the string “pizza” in the input field 502. For example, the user may be in the mood specifically for food from the “Olive Garden,” the restaurant. Thus, the user can enter “Olive Garden” to see whether any nearby Olive Garden locations are offering discounts. The user can enter any combination of words describing goods or services and/or vendors in the input field 502. Upon pressing a search button 504, the search string (i.e., the first request for the discount) that is entered in the input field 502 can be transmitted. In an example, the search string can be received by the matching module 308 of FIG. 3.

The first request for the discount can also include a location for the search. As such, the first request can include at least one of a search location and/or a good or service string. A location indicator 506 indicates that the technique 400 will find matching discounts within a geographic location that is within a predefined distance that is centered at the location of the user device (i.e., the Current Location). However, the user can modify the search location using a location control 508. Via the location control 508, the user can, for example, enter an address, select a location on a map, or the like.

If the user selects a map control 510, the technique 400 can receive a request for discounts within a predefined location of the user device. The matching discounts can be displayed (e.g., overlaid) on a map display, such as described with respect to FIG. 11. In an example, the map display can be that of a navigation application.

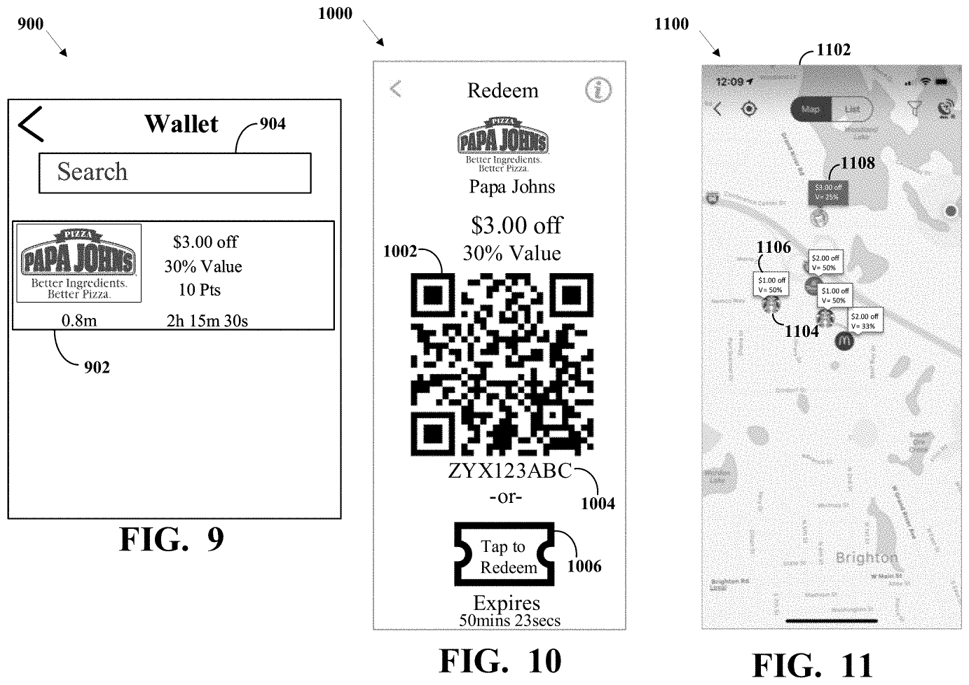

A wallet control 512 allows the user to view all the discounts that the user has saved to the user wallet (i.e., electronic wallet). An example of the user wallet is described below with respect to FIG. 9. A label 516 can display the number of accumulated award points by the user.

The location control 508 allows the user to view all the active first requests that the user has issued. FIG. 6 illustrates a list 600 of active first requests in accordance with implementations of this disclosure. The list 600 includes two active first requests, namely an active search 602 and an active search 606.

The active search 602 indicates that the search is for “Pizza” and that 11 matching discounts have been returned so far. The maximum discount value of the 11 matching discounts is 50%. Additionally, a status indicator 604 indicates that matching discounts can still be received for another 30 seconds. That is, the status indicator 604 indicates the remaining bidding time.

The active search 606 indicates that the search is for the service “Car Wash” and that three matching discounts have been returned. The maximum discount value of the three matching discounts is 40%. Additionally, a status indicator 608 indicates that matching discounts are no longer being received; but rather, any current matching discounts will be available to the user for the next 1 hour, 25 minutes, and 35 seconds. Thus, a status can be associated with each current search. The status can be one of “Active,” “Expiring,” or “Expired.”

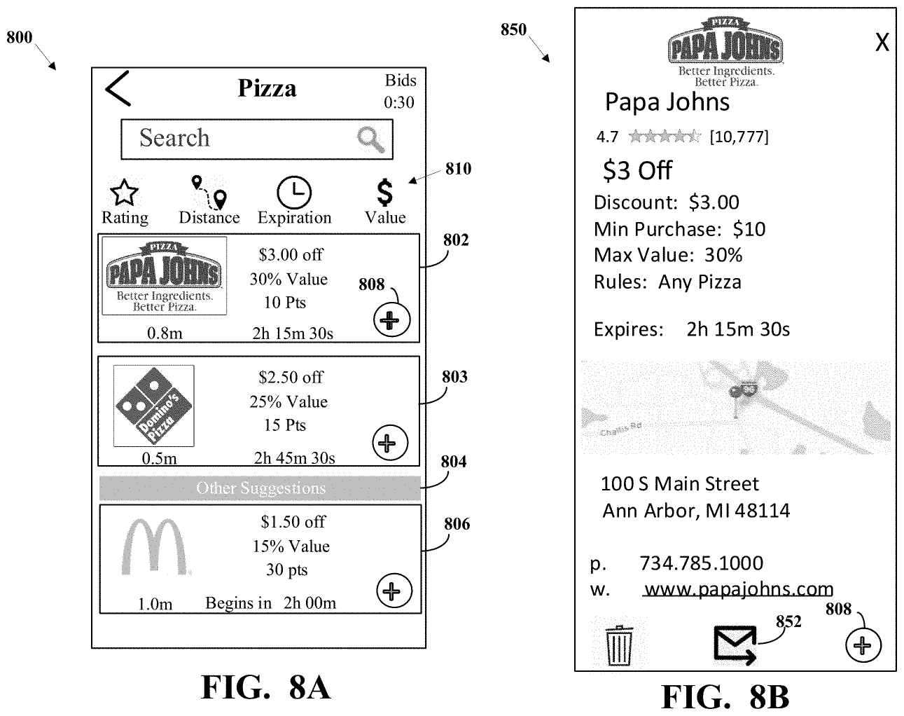

In an example, the user, via a user interface control (not shown), can extend the remaining bidding time. In an example, the user can extend the bidding time for the request itself (i.e., for all vendors who have active campaigns matching the user's request). In another example, the user can extend the bidding time for only a select number of vendors. For example, the user can select one of more of the matching discounts, which are shown in FIG. 8A, and extend the bidding time for those vendors of the selected matching discounts.

In an example, a vendor whose bidding time has been extended by the user can respond to the extension of the bidding time by revising (i.e., updating, etc.) the vendor's matching discounts. In an example, the vendor whose bidding time has been extended can respond with a message indicating that the vendor cannot revise the vendor's matching discounts. In an example, the vendor whose bidding time has been extended does not respond.

The “Active” status can indicate that matching discounts can still be received for the first request; the “Expiring” status can indicate that no matching discounts can be further received/matched for the first request and that the matched discounts can be available for a given period of time; and the “Expired” status can indicate that the user has previously performed the search but that any matching discounts of the expired search may no longer be available. Other statuses and/or status labels can be available.

Returning to FIG. 4, at 404, the technique 400 identifies, based on the first request, matching discounts from respective vendors. At least some of the matching discounts can have respective expiration timestamps. In an example, identifying the matching discounts from the respective vendors can include identifying an active campaign of a vendor, and matching the first request to the active campaign.

In an example, a vendor can create one or more campaigns. Each campaign can include rules. A campaign can be active for a period of time and/or during specific time periods within designated days, A matching discount can be identified based on (i.e., by matching) the first request and the rules of the active campaigns.

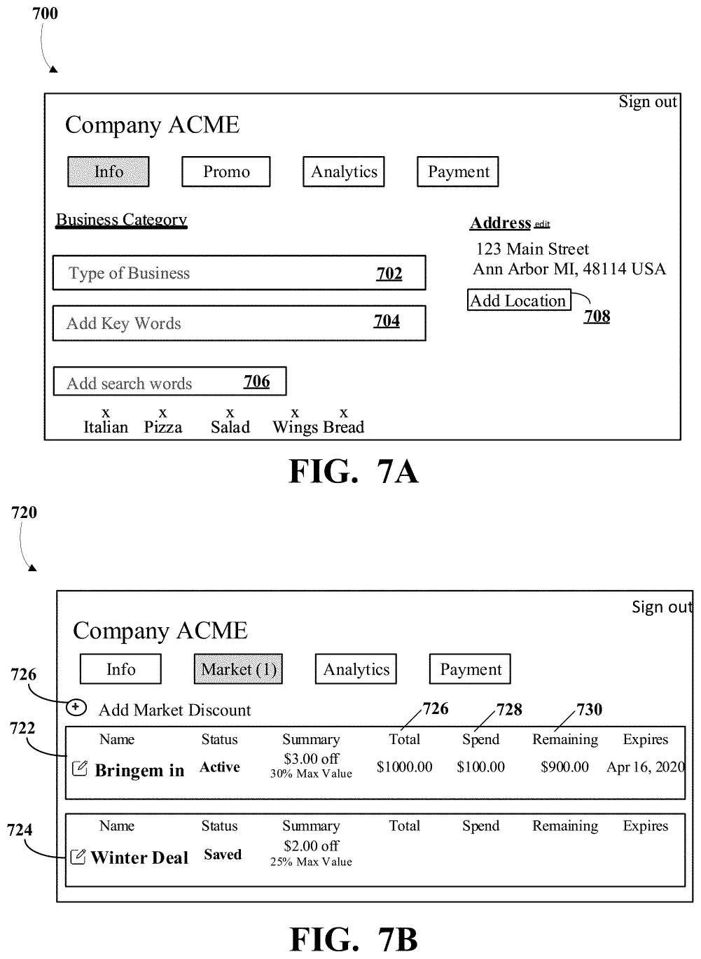

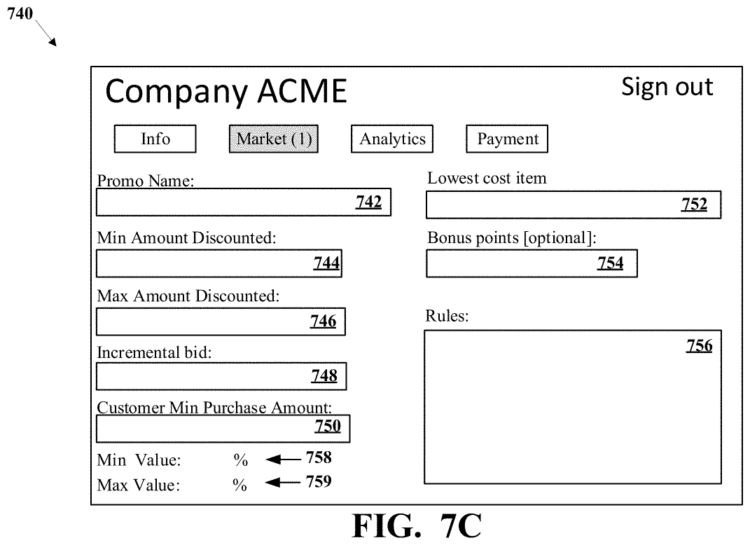

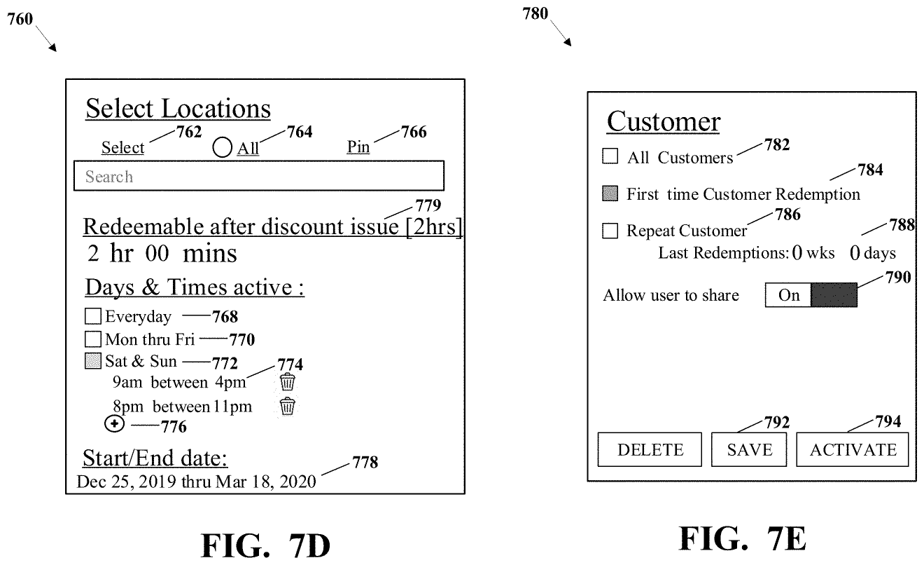

FIGS. 7A-7E illustrate, respectively, user interfaces 700, 720, 740, 760, 780 that can be used by a vendor including to create and/or modify campaigns in accordance with implementations of this disclosure. A vendor (i.e., a human vendor representative or a human vendor agent) can use one or more of the user interfaces 700, 720, 740, 760, 780 to create a profile of vendor and/or maintain (e.g., create, modify, copy, delete, etc.) discount campaigns. The user interfaces 700, 720, 740, 760, 780 can be generated by a vendor module, such as the vendor module 302 of FIG. 3, and/or a campaign module, such as the campaign module 306 of FIG. 3.

In an example, the vendor may be required to register and verify itself as vendor prior to creating campaigns. The vendor module 302 of FIG. 3 can implement such registration and verification processes.

The user interface 700 of FIG. 7A can be used by the vendor to provide information regarding the vendor. The information can be used to match the vendor against search terms in the first request issued by the user. The information provided by the vendor can be saved in a vendor profile. In a field 702, the vendor can provide a high level description of the type of business of the vendor. In a field 704, the vendor can provide, for example, a comma-separated list of keywords, which a matching module, such as the matching module 308 of FIG. 3, can use to match the vendor to words in the first request for the discount from the user. The keywords can be used to more accurately match vendors to the user's request. The keywords can be provided in any language or in multiple languages. In a field 706, a vendor can provide key words, which can describe the vendor's offerings and which are ultimately to be algorithmically used during a user search query and for a subsequent possible match.

The user interface 720 of FIG. 7B illustrates that the vendor, ACME, has created two discount campaigns. A campaign 722 is named “Bringem in” and has a status of “Active.” That is, the campaign 722 can be used, if applicable, to generate matching discounts in response to the first request for the discount from the user. A campaign 724 is named “Winter Deal” and is currently in the “Saved” status, which indicates that the vendor may still be editing/modifying the campaign 724 and that the vendor has not activated the campaign 724 so that the campaign 724 can be used for generating matching discounts. A control 726 can be used by the vendor to initiate the creation of a new campaign. When the vendor (i.e., the vendor representative) activates the control, the user interfaces 740, 760, 780 can be presented to the vendor for creating a new campaign.

In the user interface 740 of FIG. 7C, the vendor can provide, amongst other information, discount-related information. In a field 742, the vendor can provide a name for the campaign (e.g., “Bringem in,” or “Winter Deal” as shown in the user interface 720). In a field 744, the vendor can provide a minimum discount value. The minimum discount value can be provided as an absolute dollar value (e.g., $0.25) or as a percentage (e.g., 2%). In a field 746, the vendor can provide a maximum discount value. The maximum discount value can be provided as an absolute dollar value (e.g., $1.25) or as a percentage (e.g., 5%). In a field 748, the vendor can provide an incremental bid value, which is described below. The incremental bid value can be provided as an absolute dollar value (e.g., $0.25) or as a percentage (e.g., 1%).

Returning to FIG. 4 momentarily, identifying, at 404, the matching discounts from respective vendors can include, in an example, receiving a first discount having a first value from a first vendor; receiving a second discount having a second value from a second vendor; notifying the first vendor that the second value is greater than the first value; and, in response to the first value being smaller than the maximum discount value, receiving from the first vendor a third discount having a value that exceeds the first value by the increment amount.

To illustrate, assume that a first discount from a first vendor was generated according to the minimum discount value, which is $0.25. However, if current first discount (i.e., $0.25) is less than the discount of a second vendor, then the incremental bid value can be used to revise the first discount. Thus the revised first discount can be for the current first discount+the incremental bid value (i.e., $0.25+0.25=$0.50). This cycle of revising the discount value can repeat until the bidding time has elapsed or the maximum discount value is reached, whichever occurs first.

In an example, if the maximum discount value is reached but the bidding time has not elapsed, then the technique 400 can send a notification to the vendor. The notification can inform the vendor that the vendor's current maximum is still less than a current maximum bid from another vendor. To Illustrate, the notification can be “Your current maximum bid of $1.25 is less than that of another vendor.”

The notification can include option responses for the vendor. For example, the notification can include “respond with 1 to increase the discount once to be greater than the current maximum discount; respond with 2 to continue to increase by your incremental bid value until the bidding time expires; or respond with 3 followed by a discount value.” In some examples, one or more of the possible response options can include options for the vendor to increase the bonus points. To illustrate, the notification can, instead of the above, include “respond with 1 to increase the discount and the bonus points once to be greater than the current maximum discount.” In another example, the option responses can include an option to only increase the bonus points, such as “respond with 4 to double the bonus points without increasing the discount value.” Thus, identifying, at 404 of the technique 400, based on the first request, the matching discounts from the respective vendors can include receiving discounts to add to the matching discounts for no more than a predetermined time period (i.e., the bidding time).

For illustration purposes, assume that the current maximum discount value is $2.00 from a second vendor. If the first vendor responds with “1,” then the vendor's matching discount can be increased to the current maximum discount value of $2.00 plus the vendor's incremental bid value (i.e., $0.25). Thus, the revised matching discount from the vendor becomes $2.25. If the vendor responds with “2,” then starting at $2.25, the matching discount from the vendor can continue to be revised, as described above, by the incremental bid value until the bidding time expires. The vendor can respond with “3 $3.0” to revise the vendor's matching discount to $3.00.

As such, identifying, at 404 of the technique 400, based on the first request, the matching discounts from the respective vendors can include notifying a vendor of the request; receiving, from a vendor device of the vendor, a manual discount; and adding the manual discount to the matching discounts. In an example, the manual discount can be as described above with the “1” response. In an example, the manual discount can be as described above with the “2” response. In an example, the manual discount can be as described above with the “3” response.

In a field 750, the vendor can provide a minimum purchase amount that the discount applies to. For example, if the minimum purchase amount is $15.00, then the discount cannot be redeemed by a user to a purchase totaling less than $15.00. In an field 752, the vendor can provide a lowest cost item to which the discount applies. To illustrate, assume that the lowest cost item value provided is $1.50 and assume that the minimum purchase amount is $15.00. Assume further that a user purchased two items: one valued at $16.00 and the other is valued at $1.25. Thus, the matching discount can be redeemed only against the item valued at $16.00. In another example, the matching discount can be redeemed against an aggregate total value that is greater than $16.00.

In a field 754, the vendor can provide a number of bonus points to be awarded to a user who redeems a matching discount from this campaign. A field 756 can be used to summarize all the selections of the vendor. That is, the field 756 can be used to summarize the parameters (i.e., rules) of the campaign as provided by the vendor. A field 758 is a calculated field that can be derived using the minimum purchase amount and the minimum discount value. For example, if minimum purchase amount is $15.00 and the minimum discount value is $0.25, then the field 758 would display $0.25/$15.00=1.66%. A field 759 is a calculated field that can be derived using the minimum purchase amount and the maximum discount value. For example, if minimum purchase amount is $15.00 and the maximum discount value is $2.00, then the field 758 would display $2.00/$15.00=13.33%.

In the user interface 760 of FIG. 7D, the vendor can provide location and/or date information regarding where and when the campaign applies. That is, for example, the vendor can provide information regarding locations where discounts issued according to the campaign can be redeemed. For example, the vendor can provide days and/or times of days when discounts issued according to the campaign can be redeemed. For example, the vendor can provide a duration during which the discounts issued according to the campaign can be redeemed.

The location specified by the vendor can be one or more preset locations of the vendor. For example, the vendor can specify, using a control 762, that discounts issued according to the campaign are redeemable at specific locations. For example, at the time of setting up the vendor profile, as described with respect to FIG. 7A, the vendor can identify, using a control 708 of FIG. 7A, one or more addresses where the vendor has stores (e.g., 100 S. Main Street, Ann Arbor, Mich.; 232 Main Street, Royal Oak, Mich., etc.). Thus, the vendor can select, using the control 762, one or more of the locations that are part of the vendor profile. In an example, the vendor can specify, via a control 764, that discounts are redeemable at every location of the vendor. In an example, the vendor can pin (such as on a map), via a control 766, the location where discounts can be redeemed. For example, the vendor may be the operator of a food truck that may be at different locations at different days. Thus, the vendor can pin the location to where the food truck will be.

Thus, in an example, matching the first request to the active campaign can include matching at least one of location of the user device or the search location of the first request to the at least a subset of the plurality of locations. As mentioned above, the vendor can be associated with a plurality of locations each associated with a respective location address; the active campaign can be applicable to at least a subset of the plurality of locations; and the first request can include a search location.

As mentioned above, the vendor can provide days and/or times of days when discounts issued according to the campaign can be redeemed. For example, by selecting a control 768, the vendor can indicate that the discounts are redeemable every day of the week. For example, by selecting a control 770, the vendor can indicate that the discounts are redeemable on weekdays (i.e., Monday through Friday) only. For example, by selecting a control 772, the vendor can specify that the discounts are redeemable on weekend days (i.e., Saturdays and Sundays) only. While not specifically shown in FIG. 7D, in an example, the vendor can select any subset of the days of the week (Monday through Sunday). In an example, the vendor can select one or more specific dates. For example, the vendor can specify (such as via a calendar control) the date May 10, 2020, which is Mother's day.

The vendor can also specify specific times (i.e., available redemption times) of days (i.e., available redemption days) when discounts issued according to the campaign can be redeemed. For example, a time range 774 in combination with the control 772, which is selected, indicate that discounts according to the campaign are redeemable on Saturdays and Sundays from 9 A.M. to P.M. Using a control 776, the vendor can add additional time ranges.

As mentioned above the vendor can specify a duration during which the discounts issued according to the campaign can be redeemed. For example, a date range 778 indicates that the discounts can be redeemed between Dec. 25, 2019 (i.e., a redemption start timestamp) and Mar. 18, 2020 (i.e., a redemption expiration time). The vendor can also specify a time after the discount issues (i.e., a time after a user saves the discount to the user's wallet) within which the discount has to be redeemed. After this time, the discount is no longer redeemable. A redemption time 779 can indicate that a discount issued according to the campaign can only be redeemed within two hours of the time that the discount issued. Alternatively, the redemption time 779 can indicate that a discount issued according to the campaign cannot be redeemed before two hours of the time that the discount issued.

In an example, active campaigns can be matched only if the user is likely to be able to arrive at the vendor's location before the expiration time of the campaign. For example, a time window plus a geolocation marker can be used to determine whether the user is likely to arrive at the vendor's location. The geolocation of the user's device can be used to determine a travel time (which may be one of on foot, by car, by public transportation, or by bicycle) from the location of the user device to the vendor's location. A shortest travel time can be considered. If the travel time far exceeds the time remaining time before the campaign expires, then no matching discounts are returned. For example, a user queries for “pizza” while the user is in sufficiently close to a Pizza Hut location and Pizza Hut has an active campaign that is expiring in two minutes. Since the user can arrive at that location and redeem a matching discount prior to the campaign expiring, a matching discount can be issued according to the campaign. In an example, suspension of expiration can be taken into account if the user is within a predefined geofence, as described below.

Thus, in an example, a campaign can include (i.e., can include descriptors of) at least one of a plurality of vendor locations, a redemption start timestamp, available redemption days, available redemption times, and an expiration time.

In the user interface 780 of FIG. 7E, the vendor can provide information regarding to whom the campaign applies (i.e., a description of users who can receive matching discounts according to the campaign).

The vendor can use a control 782 to indicate that anyone can save and redeem discounts issued according to this campaign. The vendor can use a control 784 to indicate that only users who have not previously redeemed discounts issued according to this campaign can redeem discounts according to this campaign. Alternatively, the vendor can use the control 784 to indicate that only users who have not previously redeemed discounts issued according to any campaign of the vendor can redeem discounts according to this campaign. The vendor can use a control 786 to indicate that discounts issued according to this campaign can only be redeemed by users (i.e., repeat customers) who have previously redeemed at least one discount issued according to any other campaign of the vendor.

If the vendor selects the control 786, then the vendor can further set a condition (i.e., a last redemption condition), using a control 788, specifying that a repeat customer must have redeemed a discount within a vendor-specified number of weeks and/or days. If the vendor does not set a last redemption condition (e.g., the vendor-specified number of weeks and days are set to a default value of zero), then any repeat customer can redeem discounts issued according to the campaign.

The vendor can use a control 790 to set whether a user who saves a discount issued according to the campaign to the user's electronic wallet is allowed to share the saved discount with another user. If so, the discount can be used by the other user. That is, the discount can be redeemed by either one of the user or the other user or by both users. As such, the vendor can select whether the discount can be transferred to another user for redemption or whether that discount can be duplicated and granted to the other user.

A control 792 allows the vendor to save the campaign to, for example, continue working on it later. A saved, but not-yet-activated campaign, cannot be used to match discounts in response to user queries. A control 794 activates the campaign. Once activated (i.e., is active) the campaign can be used to identify matching discounts in response to user queries. The controls 792, 794 can be available on any of the user interfaces 740, 760, 780 and/or on any other user interfaces.

While not specifically shown in FIG. 7E, the vendor can provide criteria to be matched with user profile criteria. For example, the vendor can provide one or more, fewer, other, or a combination of the following criteria to be matched with user profiles: gender, age, education, income, occupation, parental status (e.g., whether the user is a parent), relationship (e.g., whether the user is married, single, divorced, etc.), interests, etc. To illustrate, if the campaign is for the product “pizza” and male users, and a user enters “pizza” in the input field 502 of FIG. 5, a matching discount according to the campaign can only be identified for the user only if the user has indicated in the user's profile that he is male.

While not specifically in any of the user interfaces 740, 760, 780, the vendor can provide criteria regarding payments to a service provider, through which the vendor can create discount campaigns. The service provider can be the operator of the network server 206 of FIG. 2 or the operator of the system 300 of FIG. 3. For example, fields 726, 728, 730 of FIG. 7B indicate, respectively, a total amount that the vendor has agreed to pay the service provider for the campaign 722, how much has currently been paid by the vendor to the service provider, and the remaining amount that can be paid by the vendor to the service provider. The vendor can pay the service provider fees for creating campaigns. The vendor can pay the service provider a small amount (toward the maximum indicated in the field 726) for each discount that is saved by a user to the user's wallet and/or for each discount that is redeemed by a user.

Returning to FIG. 4, at 406, the technique 400 forwards the matching discounts to the user device. That is, after the bidding time has expired (i.e., lapsed), the matching discounts are forwarded to the user device. FIGS. 8A-8B illustrate matching discounts in accordance with implementations of this disclosure. A list 800 illustrates a display of the matching discounts on the user device, which can be the user device 202 of FIG. 2. A details user interface 850 illustrates details of one of the matching discounts.

In another example, matching discounts are forwarded to the user device as soon as a predetermined minimum number of matching discounts are identified. The list 800 can be updated as long as the bidding time has not expired. That is, while the bidding time has not expired, the technique 400 can forward newly identified matching discounts. Newly identified matching discounts are new matching discounts or updated matching discounts that have been received since the last time that time that matching discounts were forwarded to the user device.

The list 800 of FIG. 8A indicates that 2 discounts matched the user's query for “Pizza;” namely, a discount 802 and a discount 803. Each of the matching discount can include information regarding the matching discount. The information regarding the matching discount can include an identifier of the vendor (such as the name and/or logo of the vendor), a distance of the vendor's location to location specified by the user in the query (e.g., the geolocation of the user device), a dollar value of the discount, a percent value of the discount, a validity time, fewer, more, other information or a combination thereof. To illustrate, in the discount 802, the identifier of the vendor is the name, logo, and tagline of “PAPA JOHNS,” the distance of the vendor's location to the user device is 0.8 miles (i.e., “0.8 m”), the dollar value of the discount is $3.00, the percent value of the discount is 30%, and the discount is valid for the next 2 hours 15 minutes and 30 seconds. The discount 802 also includes reward point information (i.e., “10 Pts”) indicating that if the user redeems the discount, the user will be awarded 10 reward points. By selecting a control 808, the user can add the discount 802 to the user's wallet (i.e., electronic wallet).

In some implementations, the matching discounts can include related discounts. For example, the list 800 includes an other suggestions section 804, which can include matching discounts of a related products and or services to those entered by the user. A discount 806 illustrates a related discount. The discount 806 is for hamburgers, which is related to “Pizza.” As such, the matching discounts identified at 404 of the technique 400 can include first matches for goods or services matching the good or service string (e.g., the discounts 802, 803) and second matches related to the good or service string (e.g., the discount 806).

The user can sort the list 800 using one of sorting options 810. FIG. 8A illustrates that the user can sort the list by “Rating” (i.e., according to other user ratings of the vendor), by “Distance” (such as the distance from the location of the user device), by “Expiration” time from the current time, or by “Value” of the discount. Other sorting options can be available.

Each of the matching discounts (e.g., the discounts 802, 803, and 806) can be presented in the list 800 as a clickable title, which, when clicked, can display additional information regarding the discount. Alternatively, each of the matching discounts can include a control, which, when activated, can display the additional information. Details user interface 850 of FIG. 8B illustrates an example of a user interface of additional information regarding the discount 802. The details user interface 850 includes the control 808, which is as described with respect to FIG. 8A. The details user interface 850 also includes a control 852, which the user can use to share the discount 802 with another user. In an example, the control 852 can be shown in the details user interface 850 only if the user is allowed to share the discount, as described with respect to the control 790 of FIG. 7E.

Returning to FIG. 4, at 408, the technique 400 receives, from the user device, a second request to associate a selected matching discount of the matching discounts from a selected vendor with the user. For example, the second request can be received in response to the user activating the control 808 of FIG. 8A or FIG. 8B.

FIG. 9 illustrates a user interface of a wallet 900 in accordance with implementations of this disclosure. The wallet 900 includes all discounts that the user has added to the wallet. The wallet 900 includes a discount 902, which can be the discount 802 of FIG. 8A and which the user added to the wallet via the control 808. As the user may add many discounts to the wallet 900, the wallet 900 can include a search field 904, which enables the user to quickly narrow down (e.g., filter, etc.) the discounts in the wallet 900 to a subset of current interest to the user.

FIG. 10 illustrates a redemption user interface 1000 for redeeming a discount in accordance with implementations of this disclosure. In an example, the user can redeem a discount that is saved to the wallet of the user, such as the wallet 900 of FIG. 9. In an example, the user can redeem a discount directly from a list of matching discounts, such as the list 800 of FIG. 8A. The redemption user interface 1000 can be displayed in response to a user selecting a control (not shown) associated with redeeming a discount. The user can present the user interface to the vendor (i.e., to a clerk at a vendor location).

In an example, the redemption user interface 1000 can include a scan code 1002 that uniquely identifies the discount. The scan code 1002 can be a Quick Response (QR) code, a barcode, or some other scannable code that can be scanned at a point-of-sale register or device. The redemption user interface 1000 can include a code 1004. The code can be manually entered by the clerk in the point-sale-device to apply the discount to a purchase of the user.

In an example, the discount can be redeemed by the user at an e-commerce site. Thus, the user can enter the code 1004 at the time of completing the sale for the goods or services of the discount. In an example, the vendor may not have a scanning device to scan the scan code 1002. In an example, the vendor can place a unique code/password into the user's device for a registered redemption, which can be enabled by a tap-to-redeem field 1006. Upon selecting the tap-to-redeem field 1006, by the user, a request can be forwarded from the user device to a system of the vendor to redeem the discount. Other methods for redeeming discounts at a vendor's location are possible. In an example, the user can redeem the discount using an application of the vendor and the user picks up the purchased item(s) at a physical location of the vendor. The user can redeem the discount only if the user's designated pick-up physical location complies with the rules of the campaign from which the discount issued or via a virtual (e.g., an online purchase).

When the discount is redeemed, the discount is marked, such as by the technique 400 of FIG. 4, as no-longer-redeemable, redeemed, or any other status so that it can no longer be accepted. As such, in an example, the technique 400 of FIG. 4 can include receiving, from the user device, a third request to redeem the selected discount; and marking the selected discount as redeemed.

In another example, a campaign may be set up such that a discount can be redeemed multiple times until the expiration time. The multiple number of times can be a specific number of times (e.g., 2 times, 5 times, etc.). The multiple of times can be an unlimited number of times. Thus a counter can be associated with the discount to count the number of times that the discount has been redeemed by the user. In the case of the specific number of times, when the counter reaches the specific number of times, then the discount can no longer be redeemed and can be marked as no-longer-redeemable, redeemed, or any other such status.

The discount is redeemed only according to the rules of the campaign from which the discount issued. For example, if the discount applies to a minimum purchase of $15.00, yet the user's purchase is for $10.00, then the discount cannot be redeemed against the purchase. Thus the point-of-sale register or device can be in communication with the server (e.g., the network server 206) to receive discount redemption validation information.

For example, information regarding the sale transaction from a vendor system (e.g., the point-of-sale register or device, or another device of the vendor that is connected to the point-of-sale register or device) can be transmitted to the server, the server then applies (e.g., validates, etc.) the rules of the campaign to the information regarding the sale transaction. The server can then return discount redemption validation information. In an example the discount redemption validation information can include a dollar value or a percent value to be applied by the vendor. In an example, the discount redemption validation information can include a message indicating that the discount cannot be redeemed against the purchase and the reason(s) therefore. In an example, the discount redemption validation information can include the items of the purchase to which the discount does not apply. In an example, the discount redemption validation information can include a message indicating that the discount is not redeemable at the current location of the vendor.

As mentioned above, a discount can have an expiration time. Thus, a discount cannot be redeemed after the expiration time. However, in some examples, the expiration time can be temporarily suspended. For example, if the discount is about to expire while the user is standing in line at the vendor's location to complete a sale, then the expiration is suspended so that the user can redeem the discount against the sale. Similarly, the user can be proximal to (e.g., within a few yards of) the vendor's location. More generally, if the user is within a (small) geofence centered at the vendor's location, then the discount expiration time can be suspended. When the user exits the geofence, the discount is then set to expired.

As such, in an example, the technique 400 can include determining a location of the user device; and, in response to determining that the location of the user device is proximal to a vendor location of the selected vendor and that the expiration timestamp of the selected matching discount is reached, suspending the expiration time of the selected matching discount while the user device is proximal to the vendor location.

Similarly, if the user is attempting to redeem the discount at an e-commerce site, the discount expiration time can be suspended while the user is actively browsing the vendor's website and/or has added items to an electronic shopping cart at the vendor's website.

FIG. 11 illustrates a map display 1100 in accordance with implementations of this disclosure. The map display 1100 can be shown in response to the user selecting the map control 510 of FIG. 5. The map display 1100 includes a map 1102 that is overlaid with vendors with active campaigns within a geographic area. The geographic area can be a geofence (e.g., 1 miles, 2 miles, etc.) that is centered at the location of the user device. The geographic area can be centered at an address or a GPS location that is provided by the user. The geographic area can be a current route of the user. The geographic area can be along a route of the user to a destination that is specified by the user.

The map display 1100 shows that a vendor 1104 has an active campaign. A summary 1106 describes a matching discount according to the campaign. In some situations, the user may already have saved to the user's wallet a matching discount of a vendor that is shown on the map display 1100. Such matching discounts can be visually distinguished from other matching discounts. In an example, such matching discounts can be visually distinguished from other matching discounts using different background colors, patterns, or the like.

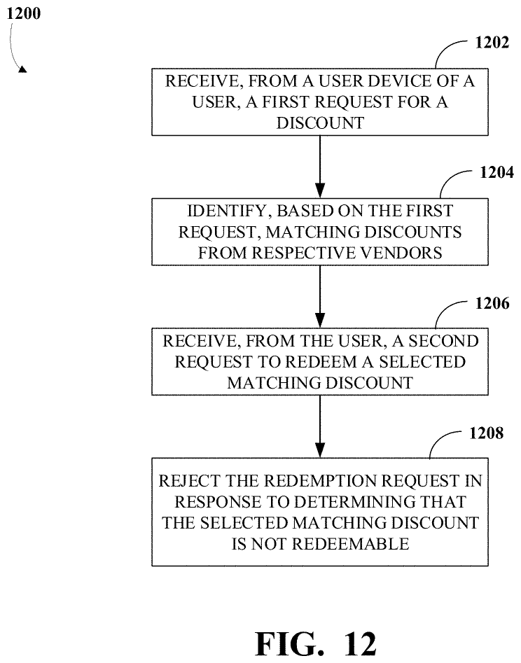

FIG. 12 is a flowchart diagram of an example of a technique 1200 that can be used in a real-time discount marketplace in accordance with an implementation of the present disclosure. The technique 1200 can be implemented by a server, such as the network server 206 of FIG. 2. The technique 1200 can be implemented by one or more of the modules of the system 300 of FIG. 3. The technique 1200 can be stored in a memory, such as the memory unit 120 of FIG. 1, as executable instructions, which can be executed by a processor, such as the processor 110 of FIG. 1.

At 1202, the technique 1200 receives, from a user device of a user, a first request for a discount. The first request can be received as described with respect to 402 of FIG. 4. At 1204, the technique 1200 identifies, based on the first request, matching discounts from respective vendors. At least some of the matching discounts include respective expiration timestamps. In an example, the matching discounts can be identified as described above with respect to 404 of FIG. 4.

At 1206, the technique 1200 receives, from the user (i.e., from a device of the user), a second request to redeem a selected matching discount from the matching discounts. In an example, the user may have saved the matching discount to an electronic wallet of the user. In another example, the user may redeem the selected request from a list, such as the list 800 of matching discounts. The user can attempt to redeem the discount as described above with respect to FIG. 10.

At 1208, the technique 1200 rejects the redemption request in response to determining that the selected matching discount is not redeemable. The matching discount is not redeemable because at least one rule associated with the campaign from which the matching discount issued is violated. In an example, determining that the selected matching discount is not redeemable can include determining that a redemption day of the selected matching discount does not match a current day of the redemption request, such as described above with respect to FIG. 7D. In an example, determining that the selected matching discount is not redeemable can include determining that a redemption day of the selected matching discount matches a current day of the redemption request but that a redemption time of the selected matching discount does not match a current time of the redemption request, as also described above with respect to FIG. 7D. In an example, determining that the selected matching discount is not redeemable can include determining that the user has previously redeemed another matching discount with an issuing vendor of the selected matching discount, such as described with respect to FIG. 7E. In an example, determining that the selected matching discount is not redeemable can include determining that the user has not previously redeemed another matching discount with an issuing vendor of the selected matching discount, as described above with respect to FIG. 7E.

Another aspect of implementations according this disclosure is a technique that includes receiving, from a user device of a user, a first request for a discount; identifying, based on the first request, matching discounts from respective vendors, wherein at least some of the matching discounts comprising respective expiration timestamps; forwarding the matching discounts to the user device; receiving, from the user device, a second request to associate a selected matching discount of the matching discounts from a selected vendor with the user; receiving, from the user, a third request to redeem the selected matching discount from the matching discounts; and determining whether to redeem the discount based on the third request satisfying a campaign associated with the selected matching discount.

For simplicity of explanation, the techniques 400 and 1200 of FIGS. 4 and 12 are depicted and described as series of steps. However, steps in accordance with this disclosure can occur in various orders, concurrently, and/or iteratively. Additionally, steps in accordance with this disclosure may occur with other steps not presented and described herein. Furthermore, not all illustrated steps may be required to implement a technique in accordance with the disclosed subject matter.

The implementations herein may be described in terms of functional block components and various processing steps. The disclosed processes and sequences may be performed alone or in any combination. Functional blocks may be realized by any number of hardware and/or software components that perform the specified functions. For example, the described implementations may employ various integrated circuit components, e.g., memory elements, processing elements, logic elements, look-up tables, and the like, which may carry out a variety of functions under the control of one or more microprocessors or other control devices. Similarly, where the elements of the described implementations are implemented using software programming or software elements the disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the implementations of the disclosure could employ any number of conventional techniques for electronics configuration, signal processing and/or control, data processing and the like.

Aspects or portions of aspects of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or a semiconductor device. Other suitable mediums are also available. Such computer-usable or computer-readable media can be referred to as non-transitory memory or media, and may include RAM or other volatile memory or storage devices that may change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. In other words, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” throughout is not intended to mean the same implementation or aspect unless described as such.

The particular aspects shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. Many alternative or additional functional relationships, physical connections or logical connections may be present in a practical device.

The use of “including” or “having” and variations thereof herein is meant to encompass the items listed thereafter and equivalents thereof as well as additional items. Unless specified or limited otherwise, the terms “mounted,” “connected,” ‘supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the disclosure (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed.

The above-described implementations have been described in order to allow easy understanding of the present disclosure and do not limit the present disclosure. To the contrary, the disclosure is intended to cover various modifications and equivalent arrangements included within the scope of the appended claims, which scope is to be accorded the broadest interpretation so as to encompass all such modifications and equivalent structure as is permitted under the law.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A method for use in a real-time discount marketplace, comprising:
receiving, from a user device of a user, a first request for a discount;
identifying, based on the first request, matching discounts from respective vendors,
wherein at least some of the matching discounts comprise respective expiration timestamps;
forwarding, after identifying the matching discounts, the matching discounts to the user device;
receiving, from the user device, a second request to associate a selected matching discount of the matching discounts from a selected vendor with the user;
determining a location of the user device; and
in response to determining that the user device is at a vendor location of the selected vendor and that the selected matching discount expires as the user is at the vendor location, suspending an expiration time of the selected matching discount while the user device is at the vendor location.

2. The method of claim 1, wherein identifying, based on the first request, the matching discounts from the respective vendors comprising:
identifying an active campaign of a vendor; and
matching the first request to the active campaign.

3. The method of claim 2,
wherein the vendor is associated with a plurality of locations each associated with a respective location address,
wherein the active campaign being applicable to at least a subset of the plurality of locations,
wherein the first request comprises a search location, and
wherein matching the first request to the active campaign comprises:
matching at least one of location of the user device or the search location of the first request to the at least the subset of the plurality of locations.

4. The method of claim 1, wherein a campaign includes a plurality of vendor locations, a redemption start timestamp, available redemption days, available redemption times, and a redemption expiration time.

5. The method of claim 1, wherein a campaign includes at least one of a description of users to receive discounts, a minimum discount value, a maximum discount value, or an increment amount.

6. The method of claim 5, wherein identifying, based on the first request, the matching discounts from the respective vendors further comprises:
receiving a first discount having a first value from a first automated agent of a first vendor;
receiving a second discount having a second value from a second automated agent a second vendor;
notifying the first automated agent of the first vendor that the second value is greater than the first value; and
in response to the first value being smaller than the maximum discount value, receiving from the automated agent of the first vendor a third discount having a value that exceeds the first value by the increment amount.

7. The method of claim 1, wherein identifying, based on the first request, the matching discounts from the respective vendors comprises:
receiving discounts to add to the matching discounts for no more than a predetermined time period.

8. The method of claim 1, wherein identifying, based on the first request, the matching discounts from the respective vendors comprises:
notifying a vendor of the first request;
receiving, from a vendor device of the vendor, a manual discount; and
adding the manual discount to the matching discounts.

9. The method of claim 1, further comprising:
in response to receiving the second request, notifying the selected vendor of the second request.

10. The method of claim 1, further comprising:
in response to determining that the location of the user device is proximal to the vendor location of the selected vendor and that an expiration timestamp of the selected matching discount is about to be reached, suspending the expiration time of the selected matching discount while the user device is proximal to the vendor location.

11. (canceled)

12. The method of claim 1, wherein the matching discounts include first matches for goods or services matching a good or service string and second matches related to the good or service string.

13. The method of claim 1, further comprising:
receiving a third request to redeem the selected matching discount; and
marking the selected matching discount as redeemed.

14. The method of claim 1, wherein identifying, based on the first request, the matching discounts from the respective vendors comprises:
identifying a matching discount from a vendor on a condition that a location of the user device and a location of the vendor are such that the user can arrive at the location before an expiration time of the discount.

15. A method for use in a real-time discount marketplace, comprising:
receiving, from a user device of a user, a first request for a discount;
identifying, until a first bidding time expires and based on the first request, matching discounts from respective vendors,
wherein at least some of the matching discounts comprise respective expiration timestamps, and
wherein the respective vendors comprise a first vendor and a second vendor;
receiving a second request from the user to extend, for the first vendor, the first bidding time to a second bidding time;
identifying, until the second bidding time expires, additional matching discounts from the first vendor but not from the second vendor;
receiving a redemption request to redeem a selected matching discount from the matching discounts; and
rejecting the redemption request in response to determining that the selected matching discount is not redeemable.

16. The method of claim 15, wherein determining that the selected matching discount is not redeemable comprises:
determining that a redemption day of the selected matching discount does not match a current day of the redemption request.

17. The method of claim 15, wherein determining that the selected matching discount is not redeemable comprises:
determining that a redemption day of the selected matching discount matches a current day of the redemption request but that a redemption time of the selected matching discount does not match a current time of the redemption request.

18. The method of claim 15, wherein determining that the selected matching discount is not redeemable comprises:
determining that the user has previously redeemed another matching discount with an issuing vendor of the selected matching discount.

19. The method of claim 15, wherein determining that the selected matching discount is not redeemable comprises:
determining that the user has not previously redeemed another matching discount with an issuing vendor of the selected matching discount.

20. A system for use in a real-time discount marketplace, comprising:
a memory; and
a processor, the processor configured to execute instructions stored in the memory to:
receive, from a user device of a user, a first request for a discount;
identify, during a first bidding time and based on the first request, matching discounts from respective vendors,
wherein at least some of the matching discounts comprise respective expiration timestamps, and
wherein the respective vendors comprise a first vendor and a second vendor;
receive a second request from the user to extend, for the first vendor, the first bidding time to a second bidding time;
identifying, in the second bidding time, additional matching discounts from the first vendor but not from the second vendor;
forward the matching discounts to the user device;
receive, from the user device, a third request to associate a selected matching discount of the matching discounts from a selected vendor with the user;
receive, from the user, a third request to redeem the selected matching discount from the matching discounts; and
determine whether to redeem the discount based on the third request satisfying a campaign associated with the selected matching discount.

21. The method of claim 1, further comprising:
receiving a request from the user to share the selected matching discount with another user; and
in response to determining that the selected matching discount is sharable with the other user, associating the selected matching discount with the other user.
